(19) United States
(12) Patent Application Publication
(10) Pub. No.: US 2009/0076871 A1
(43) Pub. Date: Mar. 19, 2009

(54) METHODS AND SYSTEMS FOR HANDLING INTERACTIONS RELATING TO CUSTOMER ACCOUNTS BASED ON A STATUS OF EXISTING TROUBLE TICKETS

(76) Inventor: Matt Heacock, Atlanta, GA (US)

Correspondence Address: AT&T Legal Department;Attn: Patent Docketing, Room 2A-207, One AT&T Way, Bedminster, NJ, 07921, US

(21) Appl. No.: 11/855,132

(22) Filed: Sep. 13, 2007

(51) Int. Cl. G05B 19/02

(52) U.S. Cl. 705/8

(57) ABSTRACT

Methods and systems handle interactions relating to customer accounts by determining the status of existing trouble tickets and then taking an action on behalf of a customer service agent based on the determined status. If no trouble tickets are currently unclosed for the customer account, then a new trouble ticket is opened. If only one trouble ticket is unclosed for the customer account, then the one trouble ticket is statused for the agent. If multiple trouble tickets are unclosed for the customer account, then those unclosed tickets are displayed within a list for selection by the agent. The list may provide the agent with the option to select a new trouble ticket should the existing trouble tickets not be applicable to the current interaction with the customer.

### TECHNICAL FIELD

Embodiments are related to trouble tickets for handling problems associated with providing goods or services. More particularly, embodiments are related to handling interactions with customers based on a status of existing trouble tickets.

### BACKGROUND

Trouble ticketing systems are typically used by entities such as service providers to track problems associated with providing a good or service to customers. Trouble tickets may come about by a problem being reported to the goods or service provider by the customer or through some related manner of fault detection. The trouble ticket documents what is known about the problem, assigns a reference identifier for the problem, and provides a manner of tracking a status of the problem by assigning a status to the trouble ticket.

The trouble ticket remains in an unclosed state while the problem is being handled. Examples of unclosed states include open and pending, and there may be various other unclosed states as well, depending upon the level of detail an entity wishes to track. An open status may mean that the trouble ticket has been created to acknowledge the problem but that work has not begun to resolve the problem. Pending may mean that work has begun to resolve the problem but has not yet concluded.

Upon a resolution to the problem being completed, the trouble ticket may be given a closed status. This indicates that work on this problem has stopped. While the work has stopped, it may be worthwhile to maintain the trouble ticket in the closed status within the trouble ticket system so that it is available for future reference.

While trouble ticket systems assist the entity in tracking and resolving problems with the service being provided, the customer service agents may have difficulty in handling customer interactions such as incoming telephone calls, electronic mail messages, incoming chat sessions, and the like. Any number of trouble tickets may exist in the trouble ticketing system for a particular customer account at a given point in time. Furthermore, a particular customer may attempt to contact the customer service department any number of times in relation to a single problem or multiple problems. With these incoming or outgoing interactions with a customer and with any number of trouble tickets in the trouble ticketing system, the agent handling the interaction may fail to associate the interaction with a proper trouble ticket. Such a mistake may delay the resolution to the problem and/or undermine the effectiveness of tracking and statusing of existing trouble tickets.

### SUMMARY

Embodiments address issues such as these and others by handling interactions based on the status of existing trouble tickets for a customer account to which the interaction pertains. The status of the trouble tickets for the customer account is determined. A new trouble ticket is opened when no trouble tickets are unclosed for the account so that the agent may enter the information pertaining to this interaction. Other actions may be taken if there are unclosed trouble tickets. For instance, if only one unclosed trouble ticket exists for the account, then that one unclosed trouble ticket may be statused so that the agent can view the details of that one unclosed trouble ticket. If multiple unclosed trouble tickets exist for the account, then a list of them may be displayed so that the agent can select whichever, if any, is pertinent to the current interaction.

Embodiments provide a computer-implemented method of handling an interaction relating to a customer account. The method involves determining whether any trouble tickets are currently unclosed for the customer account by performing a look-up of the customer account in a trouble ticket status table. When no trouble tickets are currently unclosed for the customer account, then a new trouble ticket is created that is associated with the customer account in response to the received interaction. When only one trouble ticket is currently unclosed for the customer account, then the one trouble ticket is statused. When a plurality of trouble tickets is currently unclosed for the customer account, then a list is displayed with user selectable entries that include the plurality of unclosed trouble tickets.

Embodiments provide a computer readable medium containing instructions that perform acts that include determining whether there are any unclosed trouble tickets for a customer account. When no trouble tickets are currently unclosed for the customer account, then a new trouble ticket is created that is associated with the customer account in response to the received interaction. When only one trouble ticket is currently unclosed for the customer account, then the one trouble ticket is statused. When a plurality of trouble tickets is currently unclosed for the customer account, then a list is displayed with user selectable entries that include the plurality of unclosed trouble tickets.

Embodiments provide a computer system for handling interactions relating to customer accounts that includes storage containing customer account identifiers stored in association with trouble tickets where the trouble tickets are either closed or unclosed. A processor is included and receives an inquiry regarding a customer account. The processor looks up the customer account in the storage in response to the inquiry and determines whether any trouble tickets are unclosed for the customer account. When no trouble tickets are currently unclosed for the customer account, then the processor creates a new trouble ticket that is associated with the customer account in response to the received interaction and provides the new trouble ticket for display. When only one trouble ticket is currently unclosed for the customer account, then the processor statuses the one trouble ticket including providing it for display. When a plurality of trouble tickets are currently unclosed for the customer account, then the processor provides a list with user selectable entries that include the plurality of unclosed trouble tickets for display.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows one example of an operating environment for the handling of customer interactions related to trouble tickets according to various embodiments.

FIG. 2 shows one example of a computer system for implementing handling of customer interactions related to trouble tickets according to various embodiments.

FIGS. 3A-3D show one example of a set of logical operations performed by a computer system to handle customer interactions related to trouble tickets according to various embodiments.

FIGS. 4-7 show one example of a sequence of screenshots for handling customer interactions related to trouble tickets where no trouble tickets are unclosed.

FIGS. 8-10 show one example of a sequence of screenshots for handling customer interactions related to trouble tickets where only one trouble ticket is unclosed.

FIGS. 11-14 show one example of a sequence of screenshots for handling customer interactions related to trouble tickets where multiple trouble tickets are unclosed.

FIGS. 15-17 show one example of a sequence of screenshots for handling customer interactions related to trouble tickets where selection of an editable interaction occurs.

FIGS. 18-20 show one example of a sequence of screenshots for handling customer interactions related to trouble tickets where selection of a read-only interaction occurs.

### DETAILED DESCRIPTION

Embodiments provide for handling of customer interactions related to trouble tickets by guiding customer service agents toward a proper action to take. Embodiments determine the status of existing trouble tickets, if any, and then present information to the agent where that information depends upon whether any existing trouble tickets are unclosed.

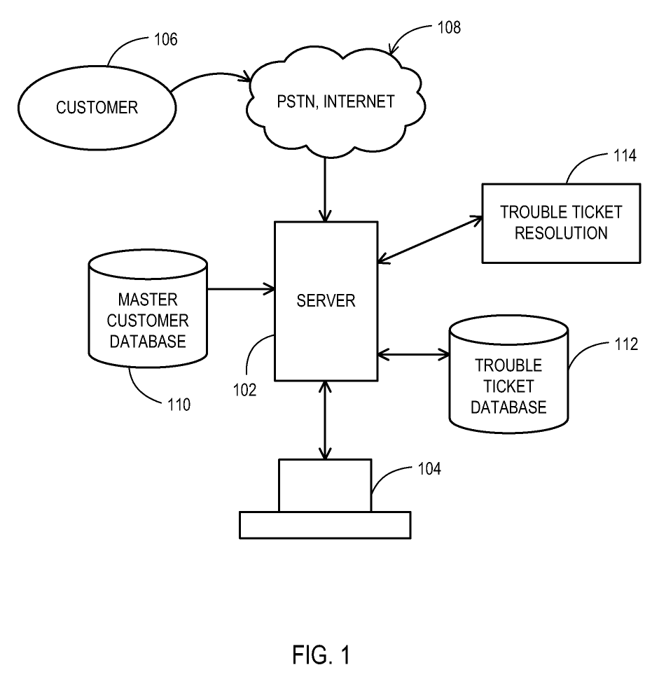

FIG. 1 shows an operating environment that includes a trouble ticket server 102. This trouble ticket server 102 may be linked to various other systems and devices. The trouble ticket server 102 may be interconnected to one or more communication networks 108, such as a public switched telephone network, the Internet, and so forth. The trouble ticket server 102 may receive an indication of incoming interactions from customers 106 via the communication network(s) 108. For example, a customer 106 may place a telephone call, send an electronic mail message, or initiate an on-line chat to contact a customer service center that includes the trouble ticket server 102.

The trouble ticket server 102 may also communicate with one or more user terminals 104 in use by customer service agents. The user terminals 104 may be standard personal computers, thin-client terminals and the like. The trouble ticket server 102 may offer information to the user terminal 104 in various formats. As one example, the trouble ticket server 102 may offer information to the user terminal 104 in the form of a web page viewable within a browser window of the user terminal 104. Other examples include providing data to trouble ticketing programs executing on the user terminals 104, providing terminal services displays to the user terminals 104, and so forth.

The trouble ticket server 102 may also communicate with various databases such as a master customer database 110 and a trouble ticket database 112. The master customer database 110 may store customer account information, such as the customer account identifier, telephone numbers associated with the customer account, names of individuals associated with the customer account, the services activated for the customer account, and so forth. The trouble ticket server 102, upon receiving an incoming or outgoing interaction with a customer, such as the customer 106, that specifies information such as a contact address, may look up the contact address within the master customer database 110 to access the customer account.

The trouble ticket server 102 may use the account identifier or other reference information to then access the trouble tickets for the customer account from the trouble ticket database 112. A given customer account may have any number of trouble tickets. Of the trouble tickets that exist, any number of them may have an unclosed state. According to exemplary embodiments, the trouble ticket server 102 detects from the trouble ticket database 112 which of those trouble tickets have the unclosed state when handing the incoming interaction from the customer 106.

The trouble ticket server 102 of this example may also interact with a trouble ticket resolution system 114. This resolution system 114 may receive trouble tickets and then proceed to assign them to appropriate personnel, generate notifications to personnel regarding the existence of trouble tickets, set severity levels of the trouble tickets, monitor for excessive duration of trouble ticket pendency, and so forth.

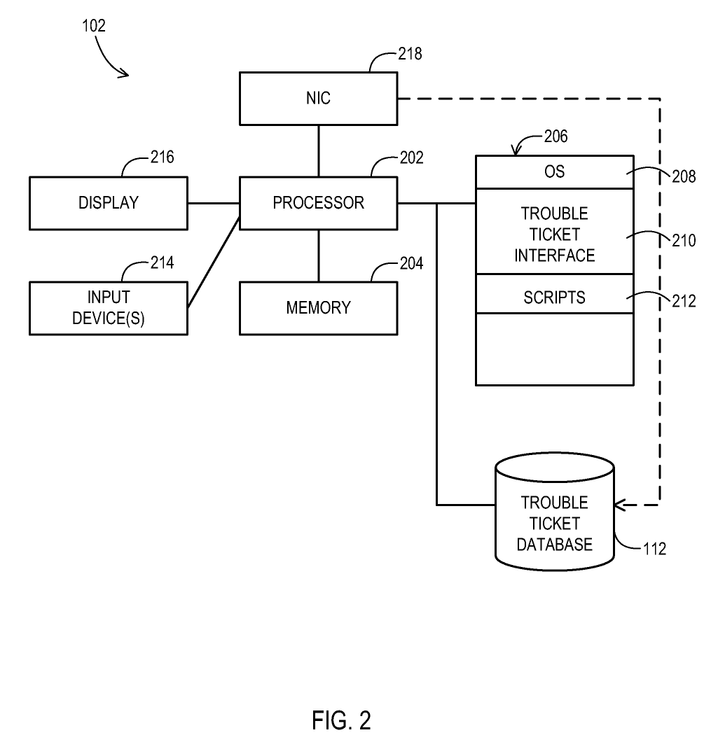

FIG. 2 shows illustrative components of one example of the trouble ticket server 102. A processor 202 may be present to perform various logical operations in order to handle the incoming interactions from the customers 106. The processor 202 may be of various forms such as a general-purpose programmable processor, an application-specific processor, hard-wired digital logic, and combinations thereof. The processor 202 may interact with various other components through a data bus, such as with a memory 204. The memory 204 may store data and/or programming to be implemented by the processor 202.

The processor 202 and/or memory 204 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

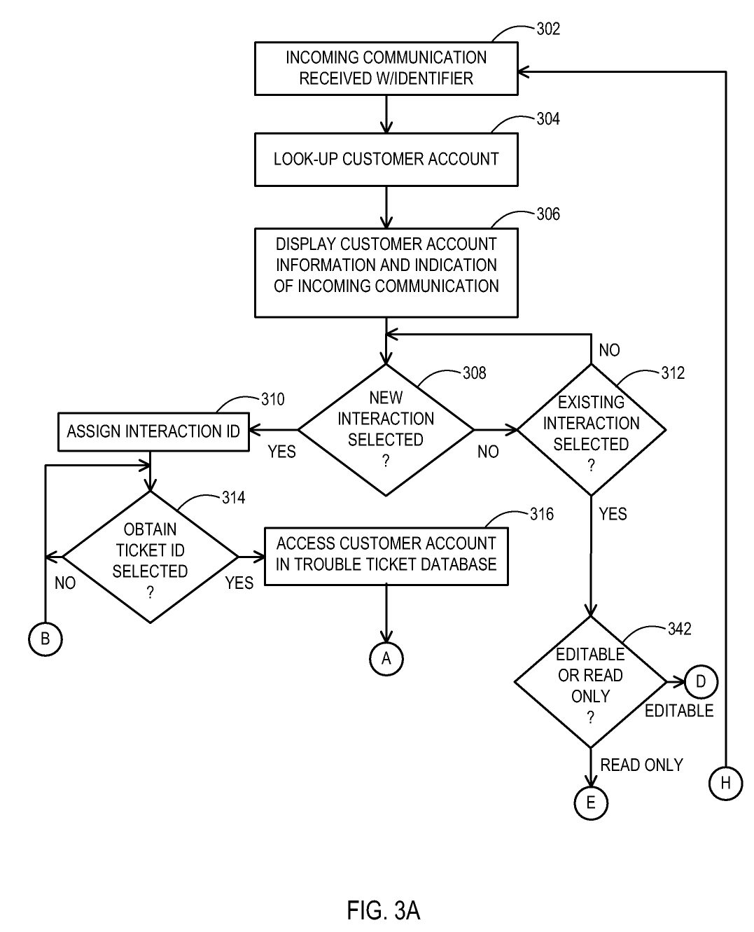

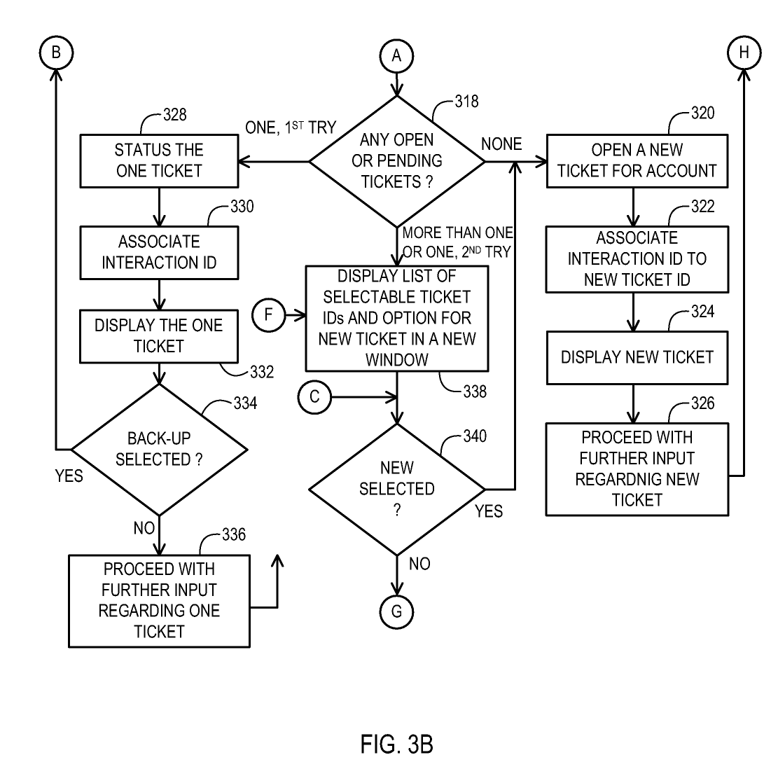

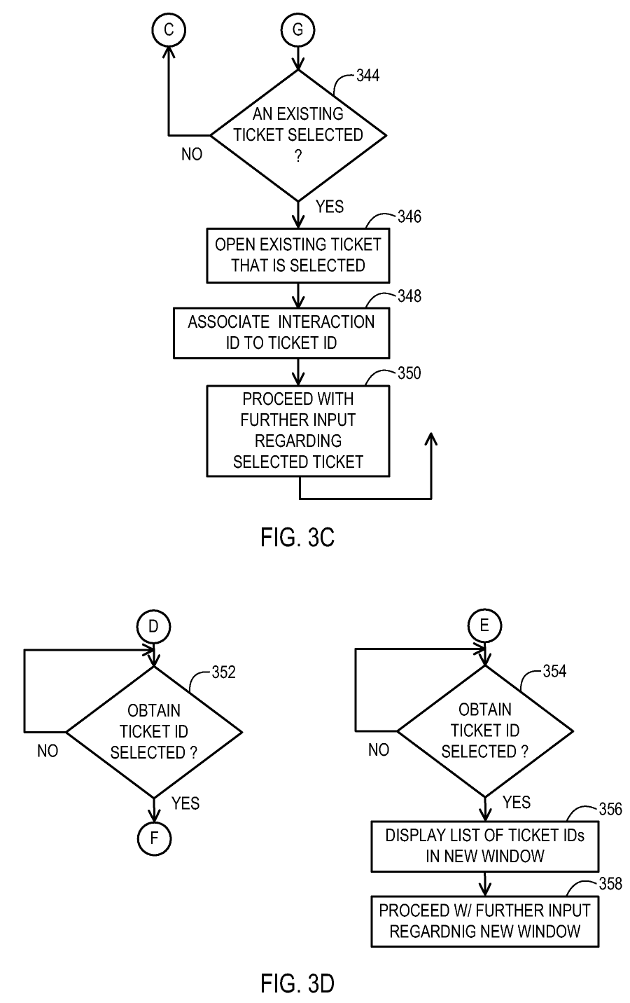

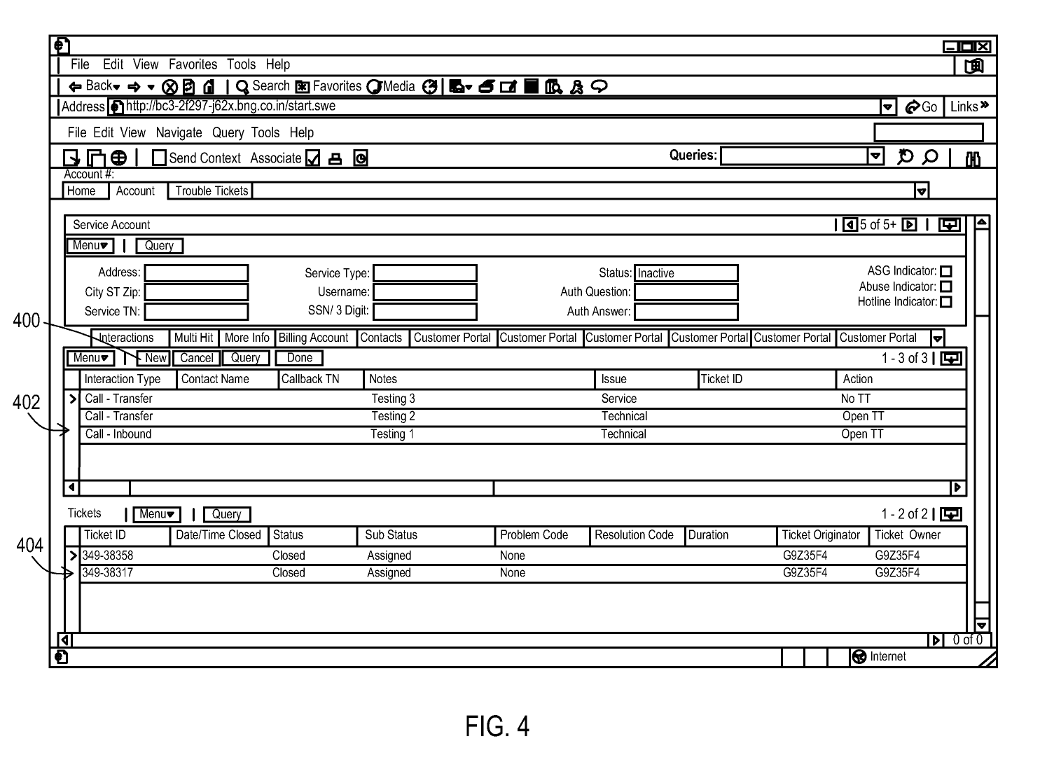

The processor 202 may also communicate with a local storage device 206 as well as remote storage devices. The trouble ticket database 112 may be integrated with the storage device 206 or may be a remotely accessible storage device. The storage device 206 may include programming and data. For example, the storage device 206 may include an operating system 208, and a trouble ticket interface program 210, and may include additional information such as custom scripts 212. As one specific example, the trouble ticket interface program 210 may be a program such as the SIEBEL RTM platform, available from ORACLE CORP. of Redwood Shores, Calif. Examples of the custom scripts 212 include scripts that introduce new functionality into the SIEBEL RTM platform as discussed below in relation to FIG. 3 and the screenshots in FIGS. 4-20.

The processor 202 may also communicate with other components, such as a display system 216. For example, a user may interact with the trouble ticket interface program 210 by directly interacting with the server 102 such that the trouble ticket interface is displayed locally via the display system 216. Furthermore, the processor 202 may communicate with input devices 214 such as a mouse, keyboard, and the like.

The processor 202 may communicate with a network interface 218 such as a wired or wireless network connection. The processor 202 may establish communications with remote devices such as the user terminal 104 and a remotely located trouble ticket database, such as the trouble ticket database 112, through the network interface 218.

One example of the logical operations being performed by the processor 202 to implement that customer interaction handling is shown in FIGS. 3A-3D. Resulting displays to a user, such as through a local display or through a display generated on the user terminal 104, are provided in FIGS. 4-20.

As illustrated in FIG. 3A, the logical operations of this example begin by the processor 202 receiving an incoming or outgoing communication with a customer, such as the customer 106, that includes an identifier at a reception operation 302. The processor 202 looks up the identifier, such as in the master customer database 110, to find the customer account at a look up operation 304. At least some of the customer account information may then be displayed along with an indication of the incoming communication at a display operation 306.

FIG. 4 shows a screenshot where a communication has occurred. Customer account information such as the address, name, service telephone number, callback telephone number and the like may be displayed. The processor 202 detects whether the user has selected for a new interaction to be created in response to the incoming communication at a query operation 308, or alternatively, if a Computer Telephony Integration (CTI) automatic generation of an interaction has occurred. The user may select a new button 400 to create the new interaction corresponding to the current call where the CTI automatic generation has not occurred, such as due to a system error or a customer refusal to pass along the calling telephone number. According to exemplary embodiments, a list 402 of existing interactions for this customer account is displayed and as shown, includes the current interaction. A list 404 of existing trouble tickets may also be shown including the status as open, pending, or closed. In the example shown in FIG. 4, all existing trouble tickets are closed.

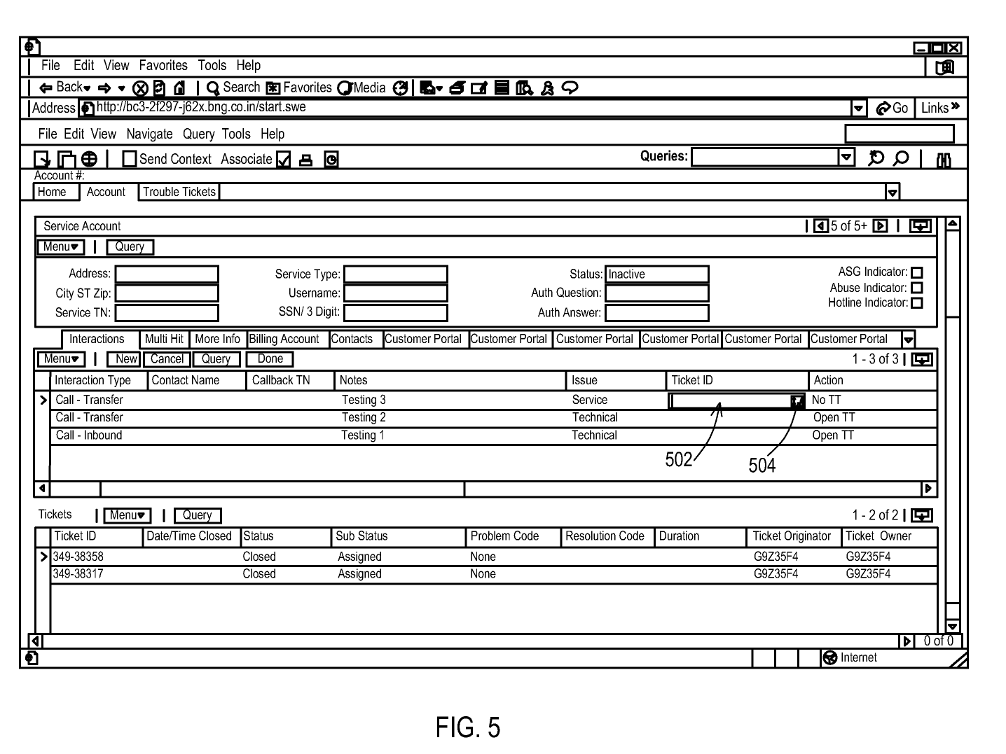

Upon the processor 202 detecting that the user has selected the new button 400 to create the new interaction or that the CTI automatic generation has occurred, the processor 202 then associates an interaction identifier to the new interaction at an identifier operation 310. The processor 202 then detects whether a button for obtaining a trouble ticket identifier is selected by the user at a query operation 314. As shown in FIG. 5, upon the user clicking into a Ticket ID field 502 of the interaction that has been created, a button 504 for obtaining a trouble ticket identifier (Ticket ID) appears and may be selected by the user. At this point, for one illustrative implementation such as where the SIEBEL RTM is used as a starting point, a custom script, such as the custom script 112, may be implemented in response to the selection of the button 504. Furthermore, the custom script 112 may be implemented each time the Ticket ID button 504 is selected in the various other screenshots discussed below.

Upon the processor 202 detecting that the user has selected the button 504 for obtaining the Ticket ID, the processor 202 then accesses the customer account in the trouble ticket database 112 at an access operation 316 by looking up the relevant customer account identifier. The processor 202 then detects from the look up whether the customer account has any unclosed tickets, which are either open or pending tickets in this example, at a look up operation 318. In this case, the processor 202 finds that there are no unclosed tickets and proceeds to open a new trouble ticket in the database 112 at a ticket operation 320. The processor 202 also associates the interaction identifier previously associated to the current interaction to the new trouble ticket at an identifier operation 322. The processor 202 then displays the new trouble ticket at a display operation 324.

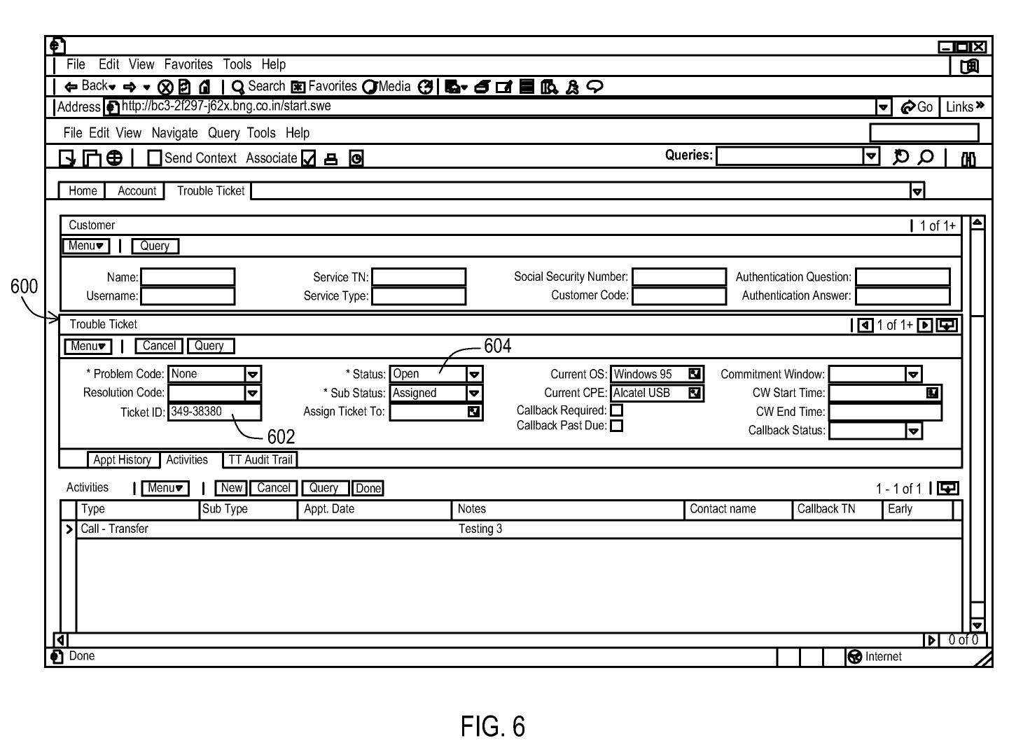

A new trouble ticket 600 is shown in FIG. 6 which provides a trouble ticket view within the trouble tickets interface. Among other information, the trouble ticket 600 includes a Ticket ID 602 and a status 604, which is currently set to open. The processor 202 then proceeds with any further inputs regarding the new trouble ticket at an input operation 326.

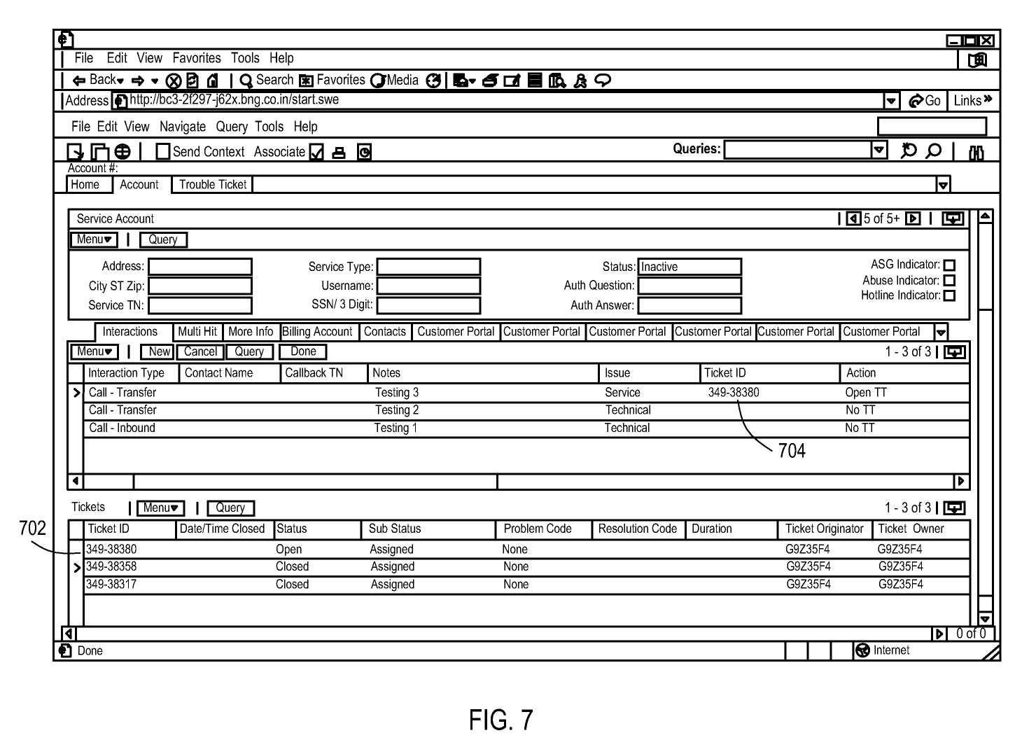

FIG. 7 shows the result of the new trouble ticket being opened at the account view of the trouble ticket interface program 210. The newly assigned Ticket ID 602 is now associated with this interaction at a field 704. Furthermore, the newly assigned Ticket ID 602 is now associated with this customer account at a field 702.

Returning to query operation 318, the processor 202 may find that only one trouble ticket 900 is currently unclosed. In that case, the processor 202 statuses the one ticket 900 by opening the information of this one unclosed ticket from the database 110 at an access operation 328. The processor 202 associates the current interaction identifier to the one unclosed trouble ticket 900 at an association operation 330 and then completes statusing of the trouble ticket by displaying it in a trouble ticket view at a display operation 332.

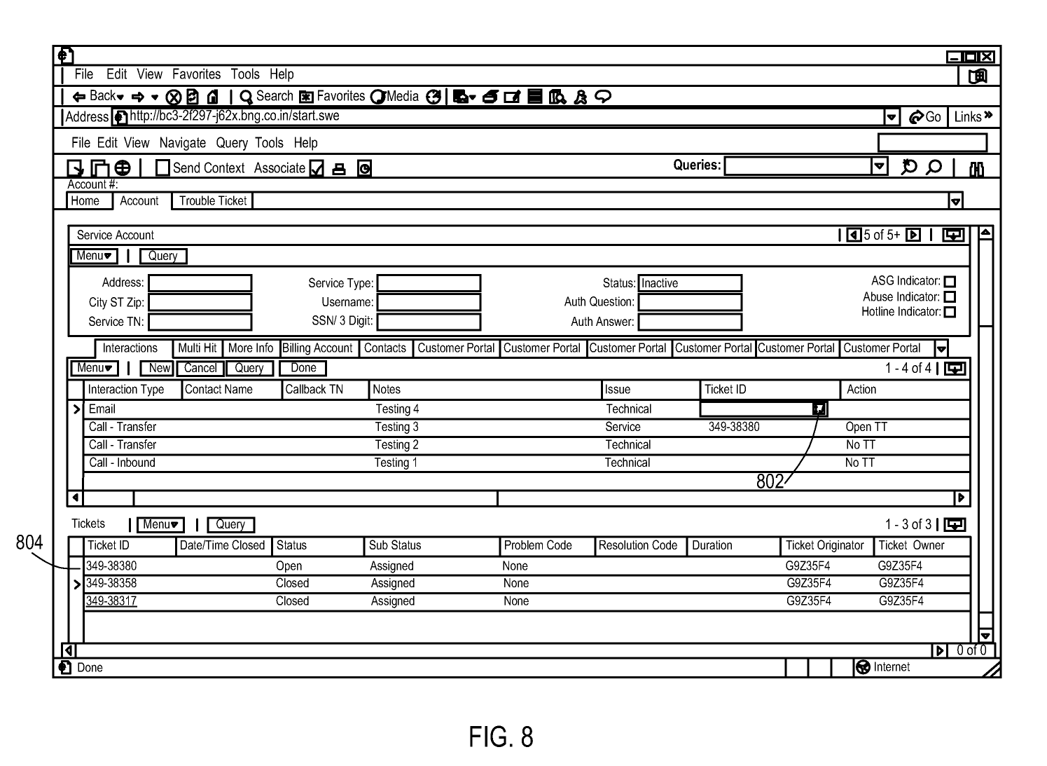

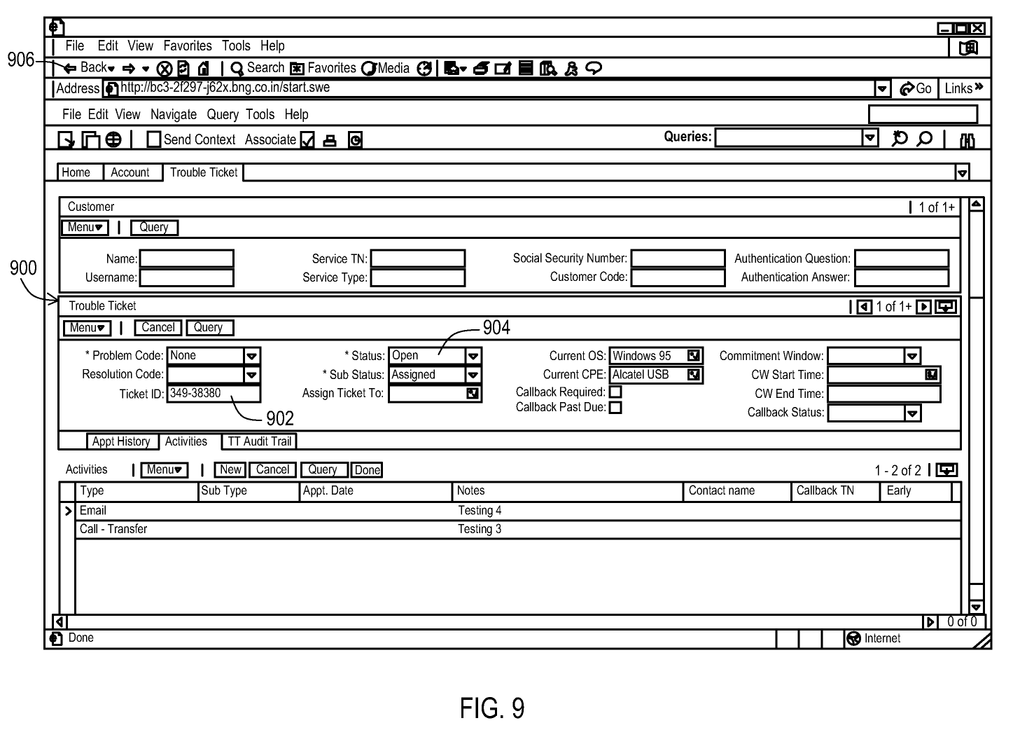

FIG. 8 shows a screen where a user selects a button 802 for obtaining a Ticket ID for the current interaction. In this case, there is only one ticket, the unclosed trouble ticket 900, currently unclosed, as shown at an item 804 for the list of existing trouble tickets. Upon selecting the button 802, the interaction identifier is associated with the one unclosed trouble ticket 900 and the one unclosed trouble ticket is displayed as shown in FIG. 9. The trouble ticket 900 is thus fully statused for the user in this example by being accessed from the trouble ticket database 112, assigned to the current interaction, and displayed. The existing trouble ticket 900 displays a Ticket ID 902 and a current status 904, which is open.

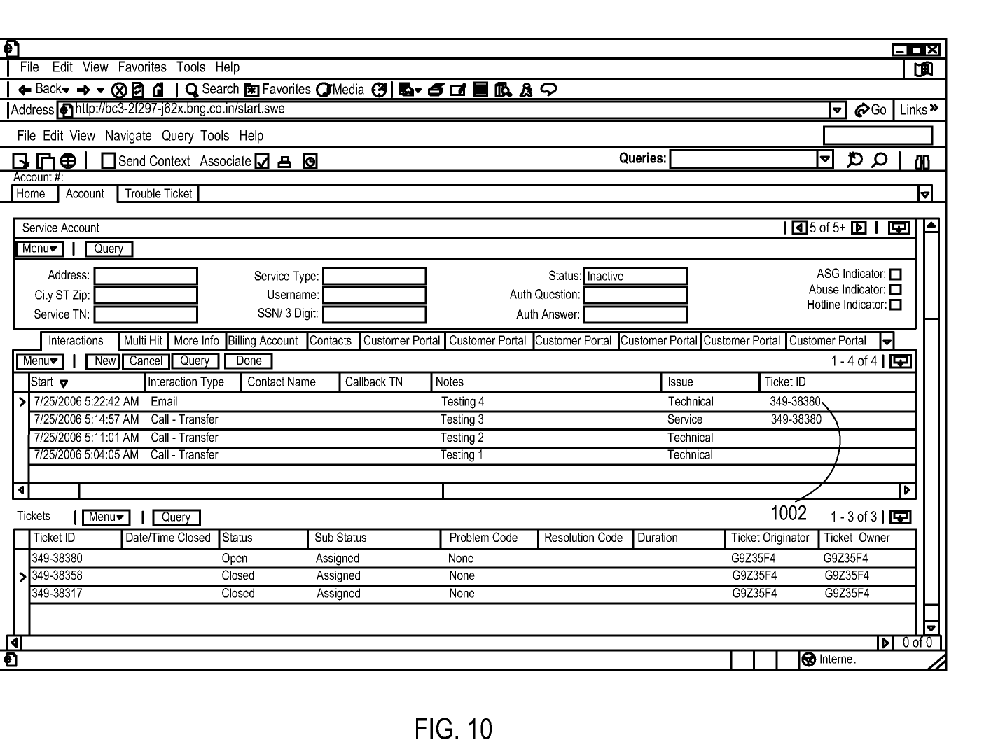

The account view of FIG. 10 shows the result of the one trouble ticket being statused, including being associated to the current interaction. As can be seen, the one unclosed Ticket ID is now associated to the current interaction at a field 1002.

Returning to the trouble ticket view of FIG. 9, the processor 202 detects whether the user has selected to return to the account view at a query operation 334. The user may wish to return to the account view if the user decides that the statused trouble ticket 900 is not applicable to the current interaction. The user may do so by selecting a browser back button 906 to return to the account view. Once there, the processor 202 begins detecting whether the user has once again selected the button 802 of FIG. 8 to try for a different trouble ticket than the currently statused trouble ticket 900, according to exemplary embodiments.

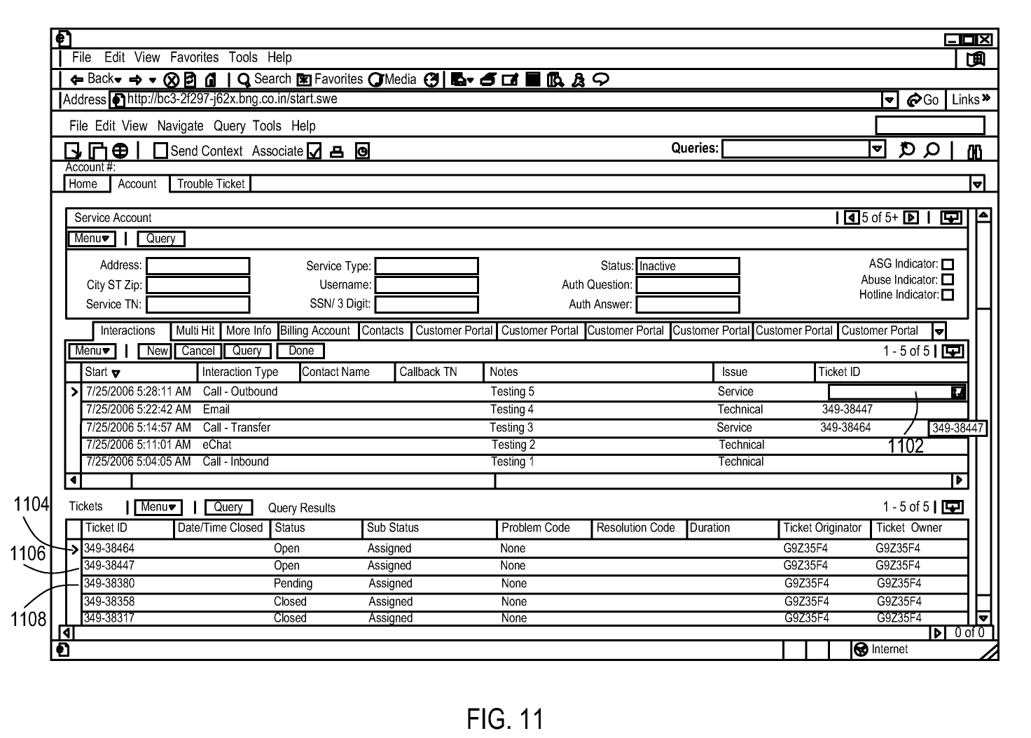

Returning to query operation 318, where the processor 202 detects that the user has selected the button 802 for the second time because the statused trouble ticket 900 was not pertinent, then operational flow proceeds to a display operation 338. Likewise, where the processor 202 detects that the customer account has more than one unclosed trouble ticket after the user has selected a button 1102 of FIG. 11, then operational flow also proceeds to the display operation 338. As shown in FIG. 11, the customer account now has three unclosed trouble tickets as indicated at entries 1104, 1106, and 1108.

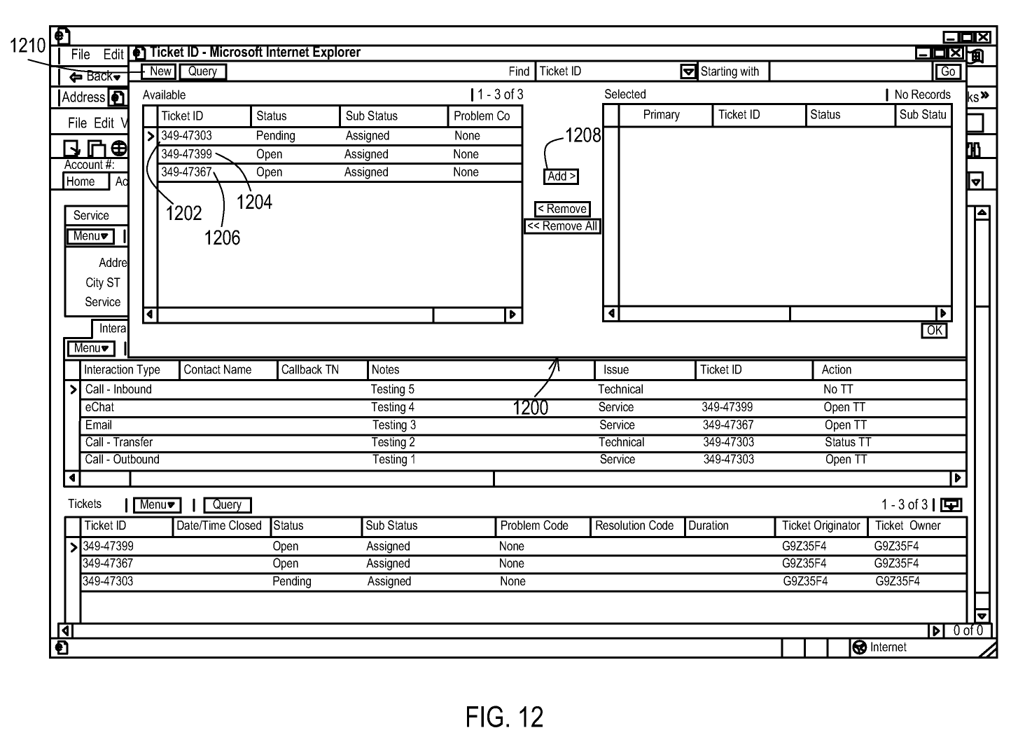

At display operation 338, the processor 202 displays a list of the Ticket IDs along with an option to create a new Ticket ID in a new window 1200. In the example shown in FIG. 12, the new window 1200 includes entries 1202, 1204, and 1206 that represent each of the unclosed trouble tickets. As can be seen, two are open and one is pending. The window 1200 may also provide the user with a button 1208 to add to the trouble ticket list that is to be opened. The window 1200 may also offer a button 1210 that is used to open a new trouble ticket, should the agent decide that none of the currently unclosed trouble tickets are pertinent to the current interaction.

At a query operation 340, the processor 202 detects whether the button 1210 to open a new ticket has been selected. For example, where only one unclosed ticket existed and the user has now been presented with this window 1200 after having selected the Ticket ID button 504 for the second time from the interactions view, the user may now select the button 1210 to open a new ticket for the current interaction. Once the button 1210 is selected, the processor 202 then opens a new window, such as the new window 1200, at ticket operation 320 and the logical operation proceeds as previously discussed above for a newly opened ticket.

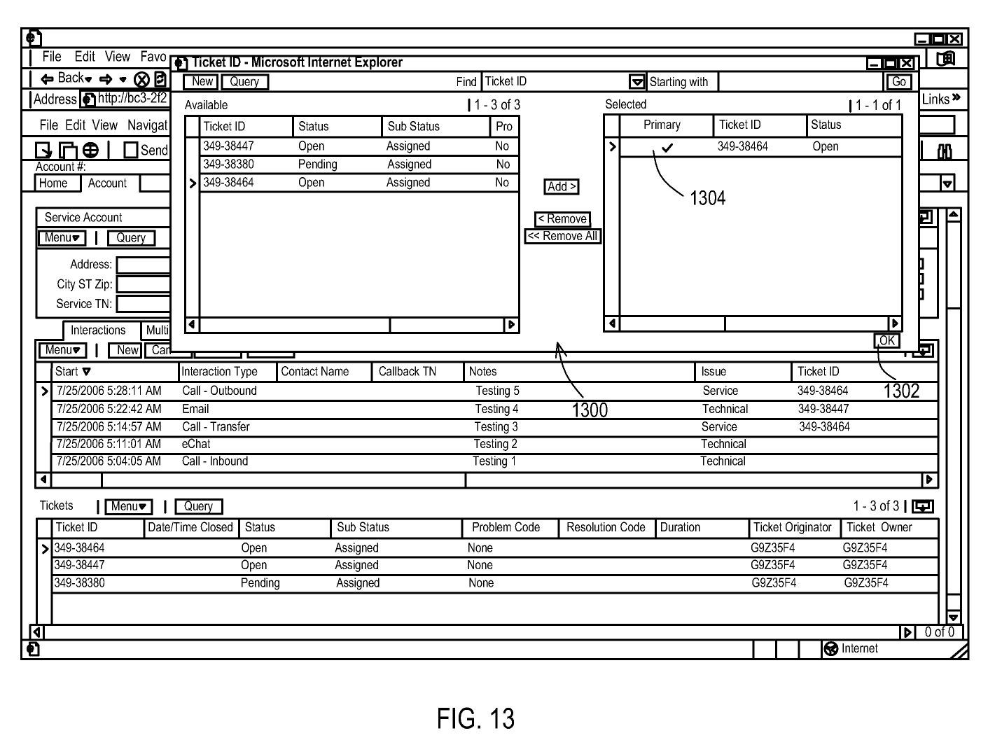

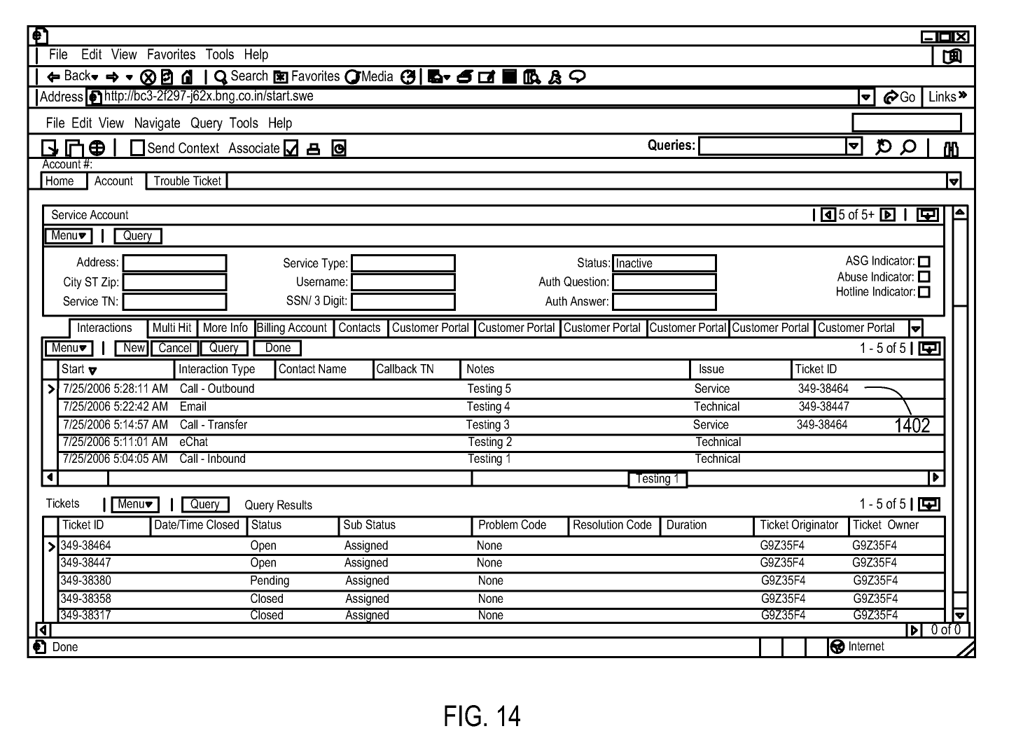

If the user has not selected to open a new ticket yet, the processor 202 detects whether the user has selected one or more existing trouble tickets from the list at a query operation 344, as illustrated in FIG. 3C. As shown in FIG. 13, the user has selected at least one ticket that is now displayed at an entry 1304. The user then selects an OK button 1302 to proceed with statusing the selected ticket(s) of the entry 1304. The processor 202 then opens the existing ticket(s) from the database 112 at an access operation 346 and associates the current interaction identifier to the existing trouble ticket(s) at an identifier operation 348. The processor 202 may then proceed with further input regarding the ticket at an input operation 350 upon displaying the selected ticket in the trouble ticket view such as shown in FIG. 9. In the interactions view of FIG. 14, the selected trouble ticket is now associated with the current interaction as indicated in a Ticket ID field 1402.

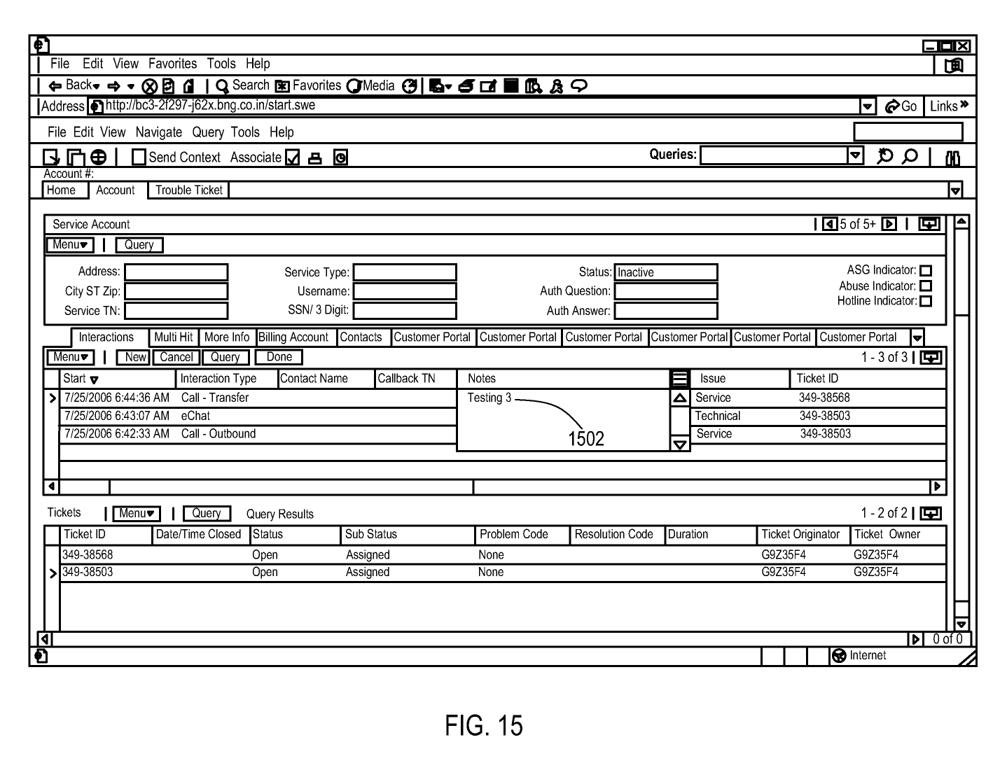

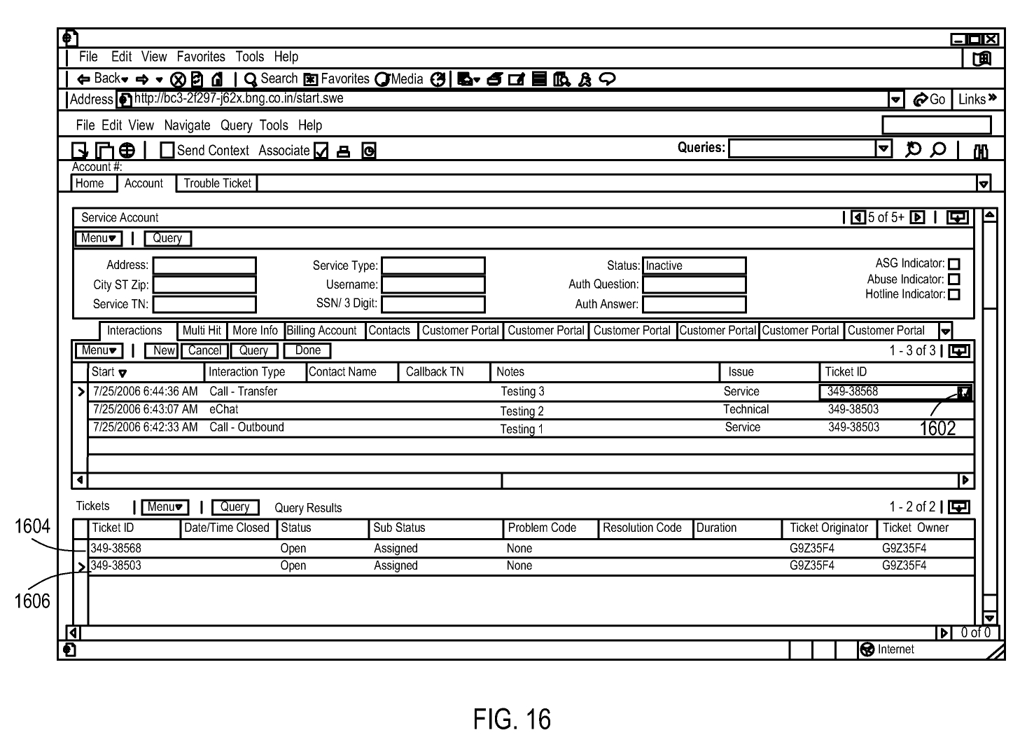

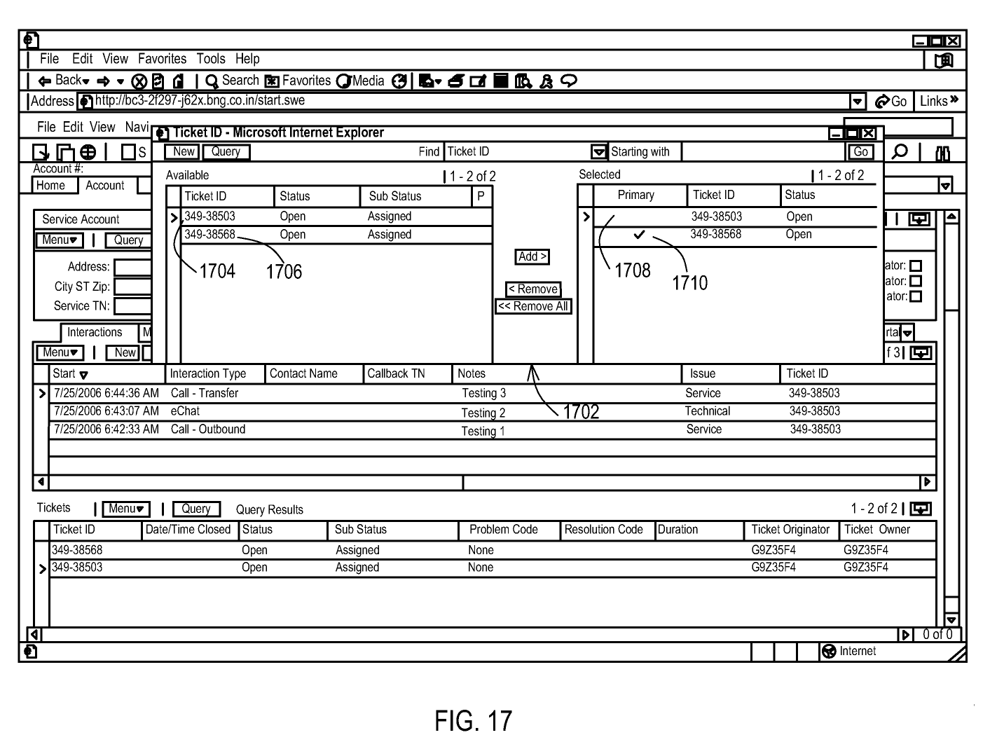

Returning to the query operation 308, where it is determined that the user has not yet selected for a new interaction to be created for a customer account, the processor 202 may detect whether an existing interaction has been selected instead at a query operation 312. Once the processor 202 detects that such an interaction has been selected, then the processor 202 detects whether the selection was made for an editable interaction or one that has been set as a read-only interaction at a query operation 342. As shown in FIG. 15, the user has selected an editable interaction within an editable field 1502. Upon the agent selecting a button 1602 of the interaction for obtaining a Ticket ID, as shown in FIG. 16, the processor 202 detects that the Ticket ID button 1602 has been selected at a query operation 352, illustrated in FIG. 3D and then operational flow proceeds to the display operation 338. There, the list of unclosed tickets is displayed within the window. As shown in FIG. 16, two tickets at entries 1604 and 1606 are open. As shown in FIG. 17, the processor 202 has displayed those tickets as entries 1704 and 1706 within a new window 1702. In this example, the user has selected both of the unclosed tickets as shown at entries 1708 and 1710. The user may then be navigated by the processor 202 to a ticket view as discussed above to show the details of any selected tickets and associate them to a current interaction identifier.

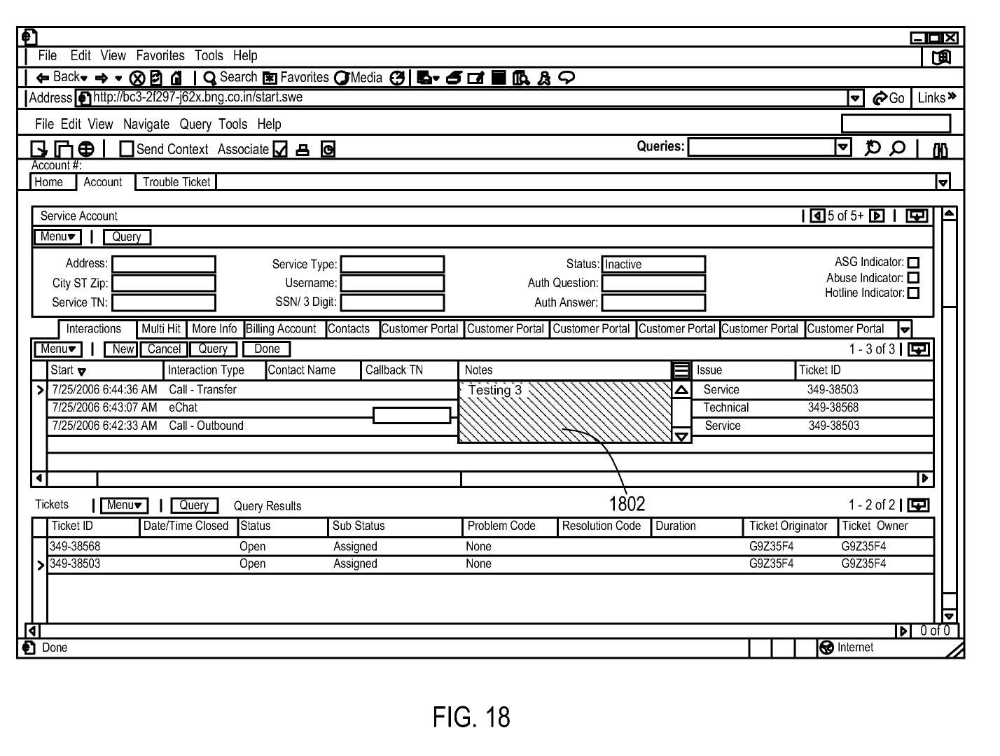

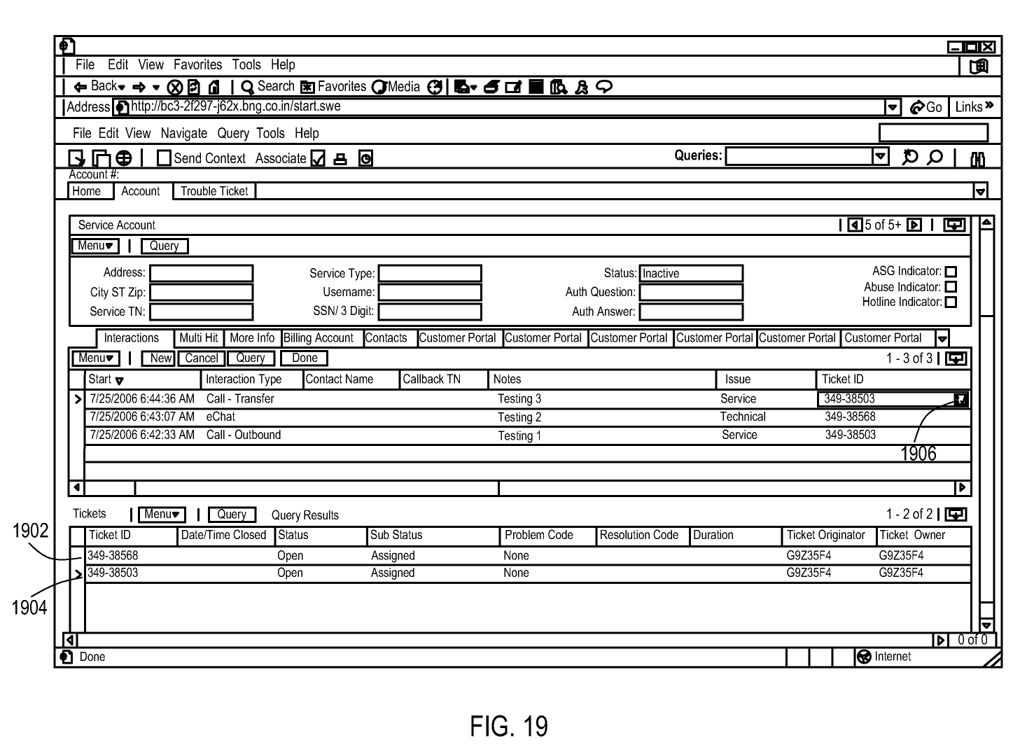

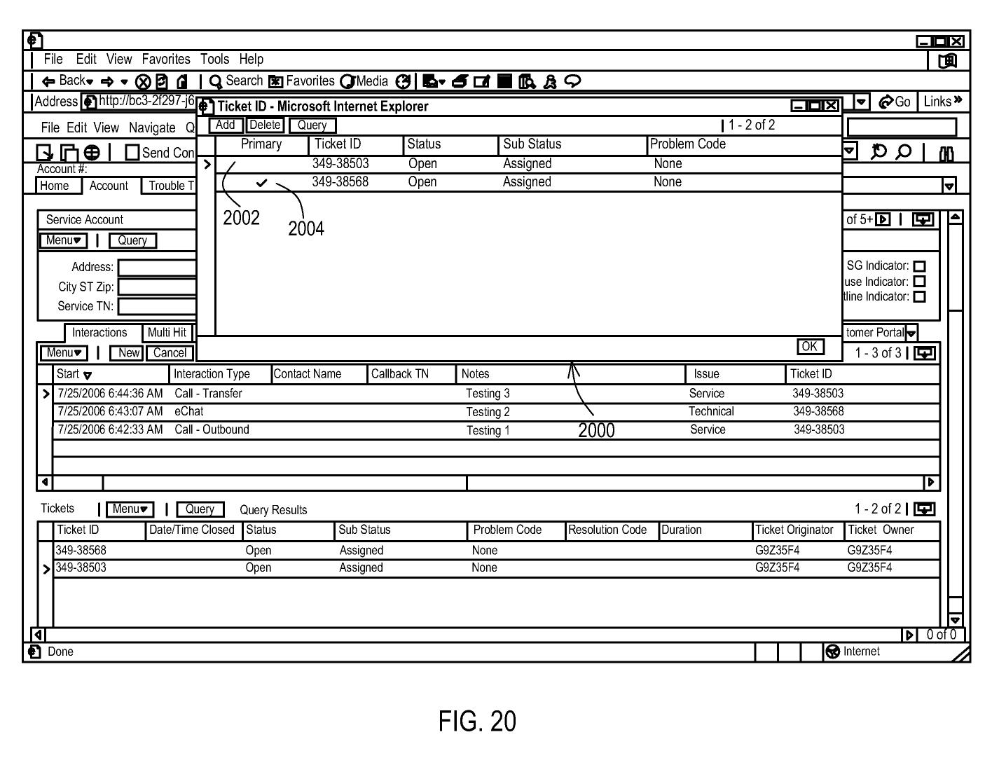

Returning to the query operation 342, the processor 202 detects that a read-only interaction has been selected, such as shown in FIG. 18 where the user has selected an interaction at a field 1802. The processor 202 then detects whether the user has selected a Ticket ID button 1906 of FIG. 19 at a query operation 354, illustrated in FIG. 3D. As can be seen in FIG. 19, this customer account has two open trouble tickets at entries 1902, 1904. When the user has selected the Ticket ID button 1906 of the read-only interaction, then the processor 202 displays a list of the unclosed trouble tickets in a new window at a display operation 356. As shown in FIG. 20, a new window 2000 includes the unclosed trouble tickets at entries 2002 and 2004. This window 2000 also allows a user to select one or more tickets so that the details of that ticket(s) may be displayed in a ticket view and the ticket(s) may be associated to a current interaction identifier. The processor 202 then proceeds with any further inputs regarding the new window 2000 at an input operation 358.

As discussed above, the embodiments take various actions to guide the customer service agent based on the status of existing trouble tickets for the customer account relevant to a current interaction. Thus, the customer service agents may be less likely to take an inaccurate action with respect to the current interaction in light of the existing trouble tickets.

While embodiments have been particularly shown and described, it will be understood by those skilled in the art that various other changes in the form and details may be made therein without departing from the spirit and scope of the invention.

What is claimed is:

1. A computer-implemented method of handling an interaction relating to a customer account, comprising:
determining whether any trouble tickets are currently unclosed for the customer account by performing a look-up of the customer account in a trouble ticket status table;
when no trouble tickets are currently unclosed for the customer account, then creating a new trouble ticket that is associated with the customer account in response to the received interaction;
when only one trouble ticket is currently unclosed for the customer account, then statusing the one trouble ticket; and
when a plurality of trouble tickets are currently unclosed for the customer account, then displaying a list with user selectable entries that include the plurality of unclosed trouble tickets.

2. The computer-implemented method of claim 1, wherein the list is displayed in a window that includes a user selectable control for opening a new trouble ticket, the method further comprising:
when a user selection of an entry for one of the plurality of unclosed trouble tickets is received, statusing the unclosed trouble ticket corresponding to the selected entry; and
when a user selection of the control for opening the new trouble ticket is selected, then opening the new trouble ticket.

3. The computer-implemented method of claim 1, further comprising:
when the new trouble ticket is created, associating an interaction identifier for the interaction with the new trouble ticket;
when the one trouble ticket is statused, associating the interaction identifier for the interaction with the one trouble ticket; and
when the list with the user selectable entries that include the plurality of unclosed trouble tickets is displayed, then receiving a user selection of one or more of the plurality of unclosed trouble tickets and associating the interaction identifier for the interaction with the selected one or more of the plurality of unclosed trouble tickets.

4. The computer-implemented method of claim 1, wherein displaying the list comprises opening a new window that contains the list.

5. The computer-implemented method of claim 1, further comprising receiving a user selection of a control for indicating a new interaction prior to determining whether any trouble tickets are currently unclosed for the customer account.

6. The computer-implemented method of claim 1, further comprising receiving a user selection of a control for obtaining a trouble ticket identifier prior to determining whether any trouble tickets are currently unclosed for the customer account.

7. The computer-implemented method of claim 6, wherein the list includes a user selectable control for opening a new trouble ticket, the method further comprising:
when only the one trouble ticket is statused, then receiving a user selection of a control to return to a view displaying the control for obtaining a trouble ticket identifier; and
upon the user selecting the control for obtaining a trouble ticket identifier for the current interaction, then displaying the list showing an entry for the one unclosed entry and including the user selectable control for opening the new trouble ticket.

8. The computer-implemented method of claim 1, further comprising:
receiving a user selection of a control for obtaining a trouble ticket identifier, the control being associated with an existing editable interaction having an existing trouble ticket identifier and being associated with the customer account; and
displaying the list with user selectable entries that include the plurality of unclosed trouble tickets for the customer account.

9. The computer-implemented method of claim 1, further comprising:
receiving a user selection of a control for obtaining a trouble ticket identifier, the control being associated with an existing editable interaction having an existing trouble ticket identifier and being associated with the customer account; and
displaying the list with user selectable entries that include the plurality of unclosed trouble tickets for the customer account.

10. A computer readable medium containing instructions that perform acts comprising:
determining whether there are any unclosed trouble tickets for a customer account;
when no trouble tickets are currently unclosed for the customer account, then creating a new trouble ticket that is associated with the customer account in response to the received interaction;
when only one trouble ticket is currently unclosed for the customer account, then statusing the one trouble ticket; and
when a plurality of trouble tickets are currently unclosed for the customer account, then displaying a list with user selectable entries that include the plurality of unclosed trouble tickets.

11. The computer readable medium of claim 10, wherein the list is displayed in a window that includes a user selectable control for opening a new trouble ticket, the acts further comprising:
when a user selection of an entry for one of the plurality of unclosed trouble tickets is received, statusing the unclosed trouble ticket corresponding to the selected entry; and
when a user selection of the control for opening the new trouble ticket is selected, then opening the new trouble ticket.

12. The computer readable medium of claim 10, further comprising:
when the new trouble ticket is created, associating an interaction identifier for the interaction with the new trouble ticket;
when the one trouble ticket is statused, associating the interaction identifier for the interaction with the one trouble ticket; and
when the list with the user selectable entries that include the plurality of unclosed trouble tickets is displayed, then receiving a user selection of one or more of the plurality of unclosed trouble tickets and associating the interaction identifier for the interaction with the selected one or more of the plurality of unclosed trouble tickets.

13. The computer readable medium of claim 10, wherein displaying the list comprises opening a new window that contains the list.

14. The computer readable medium of claim 10, wherein the acts further comprise receiving a user selection of a control for obtaining a trouble ticket identifier prior to determining whether any trouble tickets are currently unclosed for the customer account.

15. The computer readable medium of claim 14, wherein the list includes a user selectable control for opening a new trouble ticket, the method further comprising:
when only the one trouble ticket is statused, then receiving a user selection of a control to return to a view displaying the control for obtaining a trouble ticket identifier; and
upon the user selecting the control for obtaining a trouble ticket identifier for the current interaction, then displaying the list showing an entry for the one unclosed entry and including the user selectable control for opening the new trouble ticket.

16. A computer system for handling interactions relating to customer accounts, comprising:
storage containing customer account identifiers stored in association with trouble tickets, the trouble tickets being either closed or unclosed;
a processor that performs the following:
receives an inquiry regarding a customer account, that looks up the customer account in the storage in response to the inquiry,
determines whether any trouble tickets are unclosed for the customer account,
when no trouble tickets are currently unclosed for the customer account, then creates a new trouble ticket that is associated with the customer account in response to the received interaction and provides the new trouble ticket for display,
when only one trouble ticket is currently unclosed for the customer account, then statuses the one trouble ticket including provides the one trouble ticket for display; and
when a plurality of trouble tickets are currently unclosed for the customer account, then provides a list with user selectable entries that include the plurality of unclosed trouble tickets for display.

17. The computer system of claim 16, further comprising a network connection, and wherein the processor provides the new trouble ticket, the one trouble ticket, and the list for display by sending data over the network connection.

18. The computer system of claim 16, further comprising a display, and wherein the wherein the processor provides the new trouble ticket, the one trouble ticket, and the list for display by sending data to the display.

19. The computer system of claim 16, wherein the processor further performs the following:
displays a control for opening a new trouble ticket in a window containing the list;
when a user selection of an entry for one or more of the plurality of unclosed trouble tickets of the list is received, statuses the unclosed trouble tickets corresponding to the selected entries; and
when a user selection of the control for opening the new trouble ticket is selected, then opens the new trouble ticket.

20. The computer system of claim 16, wherein the processor further performs the following:
when the new trouble ticket is created, associates an interaction identifier with the new trouble ticket;
when the one trouble ticket is statused, associates the interaction identifier for the interaction with the one trouble ticket; and
when the list with the user selectable entries that include the plurality of unclosed trouble tickets is displayed, then receives a user selection of one or more of the plurality of unclosed trouble tickets and associates the interaction identifier for the interaction with the selected one or more of the plurality of unclosed trouble tickets.
